(19) United States
(12) Patent Application Publication
(10) Pub. No.: US 2014/0345434 A1
(43) Pub. Date: Nov. 27, 2014

(54) CIRCULAR BLADE FOR FOOD SLICERS

(71) Applicant: Gaetano SCATTOLIN, Oggiona Con Santo Stefano (IT)

(72) Inventor: Gaetano Scattolin, Oggiona Con Santo Stefano (IT)

(21) Appl. No.: 14/361,825

(22) PCT Filed: Nov. 28, 2012
(86) PCT No.: PCT/EP2012/073869

§ 371 Date: May 30, 2014

(30) Foreign Application Priority Data
Dec. 1, 2011 (IT) MI2011A002198

(51) Int. Cl. B26D 1/00

(52) U.S. Cl. CPC B26D 1/0006; B26D 2001/002; B26D 2001/006
USPC 83/676

(57) ABSTRACT

A circular blade for slicing machines, particularly for slicing machines of the industrial type, which comprises a substantially disk-like central body and a peripheral annular body, which is integrally connected to a perimetric edge of the central body and forms a cutting edge of the blade. The peripheral annular body is harder than the central body and the central body has a plurality of radial stiffening ribs.

The present invention relates to a circular blade for slicing machines, particularly for slicing machines of the industrial type. More particularly, the present invention relates to a blade designed to be used to slice food such as cured meats, cheese, meat, vegetables, fruits and other similar products.

As is known, circular blades for slicing machines of the industrial type, for example for slicing large quantities of food such as cured meats, cheese, meat, vegetables, fruits and other similar products are subjected to very demanding operating conditions. In fact, these blades are generally actuated with rotation rates substantially comprised between 2000 and 3000 rpm and therefore are subjected to very high stresses both as regards the loads that they must bear and as regards the abrasive phenomena that are generated by friction in cutting.

The high loads can cause deformations of the blade that lead to irregular cutting, whereas the abrasive phenomena wear the cutting edge of the blade, requiring its sharpening in order to restore its efficiency.

For these reasons, the design of these blades has always been aimed at providing blades that ensure high resistance to deformation and durable sharpness.

Currently commercially available circular blades for slicing machines of the industrial type are generally provided by means of a monolithic body made of alloy steel for tools, which is hardened by induction at the peripheral ring. This hardening is able to achieve, for this region of the blade, a hardness of approximately 59-61 HRC that ensures a lifetime of the blade, between two successive sharpening processes, of approximately two or three hours, under the ordinary conditions of use of these blades.

These blades, in order to ensure adequate corrosion resistance, must be necessarily subjected to a galvanic plating treatment with a layer of hard chromium that has a thickness of approximately 6-8 microns.

Circular blades have also been proposed which are capable of ensuring suitable corrosion resistance without requiring galvanic plating treatments. These blades are made of stainless steel, a material that ensures excellent corrosion resistance characteristics but has less than fully satisfactory mechanical characteristics for which obviation has been attempted by means of particular shapes of the blade, without however succeeding in obtaining a fully satisfactory durability of the sharpening.

In practice, currently commercially available circular blades for slicing machines of the industrial type, under normal operating conditions, are capable of ensuring a maximum duration of approximately 2-3 hours between two successive sharpening processes and therefore must be frequently disassembled, washed with degreasing products, sharpened again and cleaned again before being reassembled on the slicing machine. These interventions, besides requiring the use of an operator, constitute machine downtime and therefore lost productivity.

The aim of the present invention is to provide a circular blade, particularly for slicing machines of the industrial type, that ensures a longer duration, between two successive sharpening processes, than is obtainable with blades of the traditional type.

Within this aim, an object of the invention is to provide a circular blade that can have, in the region of the cutting edge, a greater hardness than currently commercially available blades.

Another object of the invention is to provide a blade that ensures a high corrosion resistance without requiring plating treatments.

A further object of the invention is to provide a blade that has a suitable resistance to deformation so as to ensure precise and constant cutting operations.

Yet another object of the invention is to provide a blade that is easy and quick to clean.

This aim and these and other objects that will become more apparent hereinafter are achieved by a circular blade for slicing machines, particularly for slicing machines of the industrial type, characterized in that it comprises a substantially disk-like central body and a peripheral annular body, which is integrally connected to the perimetric edge of said central body and forms the cutting edge of the blade, said peripheral annular body being harder than said central body and said central body having a plurality of radial stiffening ribs.

Further characteristics and advantages of the invention will become more apparent from the description of a preferred but not exclusive embodiment of the blade according to the invention, illustrated by way of non-limiting example in the accompanying drawings, wherein:

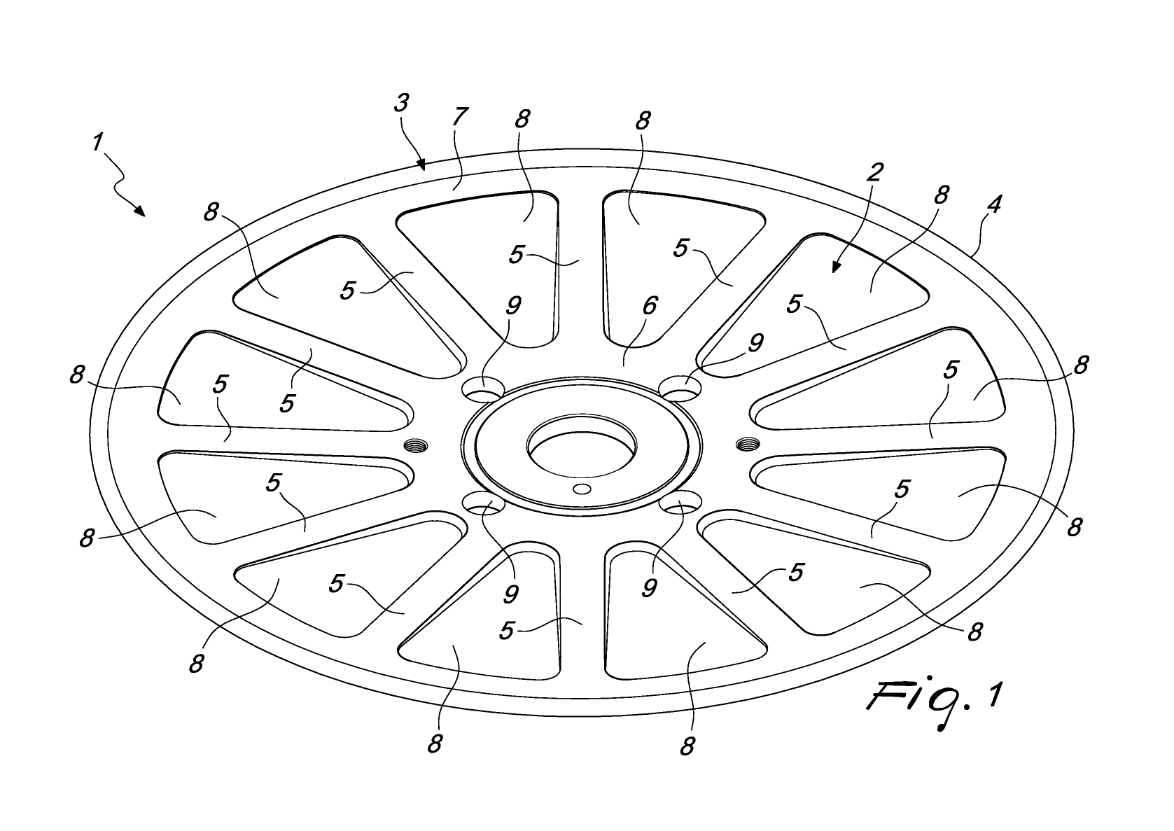

FIG. 1 is a perspective view of the blade according to the invention;

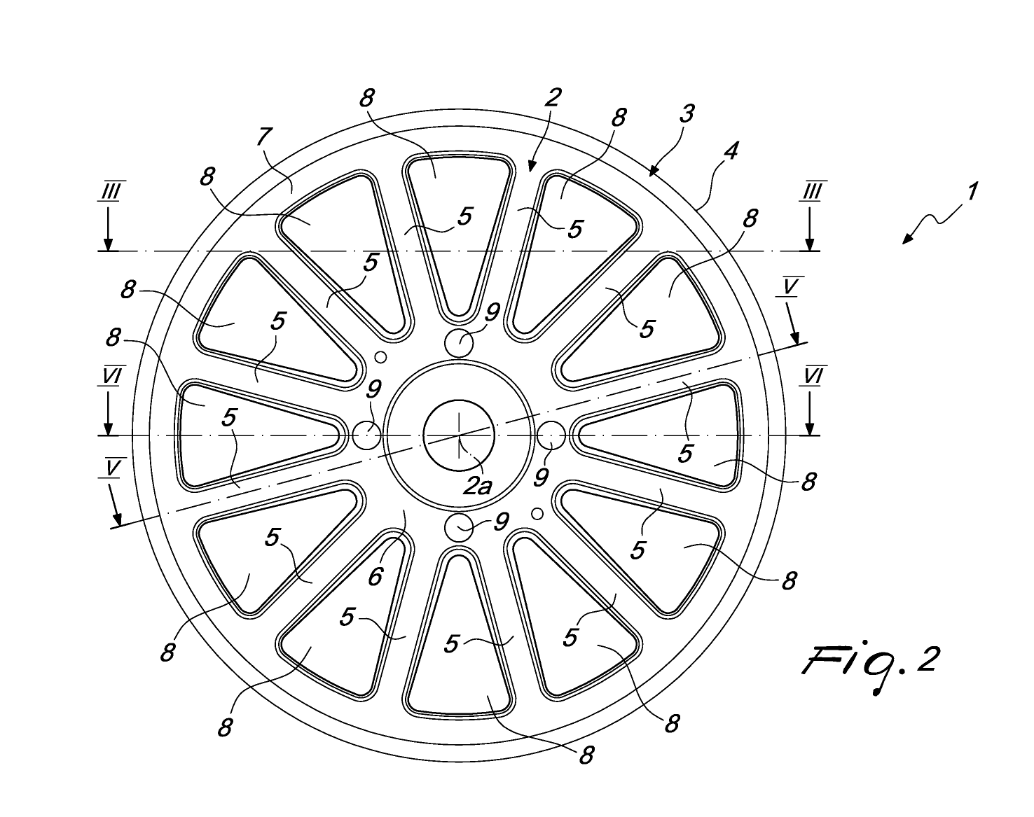

FIG. 2 is a top plan view of the blade according to the invention;

FIG. 3 is a sectional view of FIG. 2, along the plane III-III;

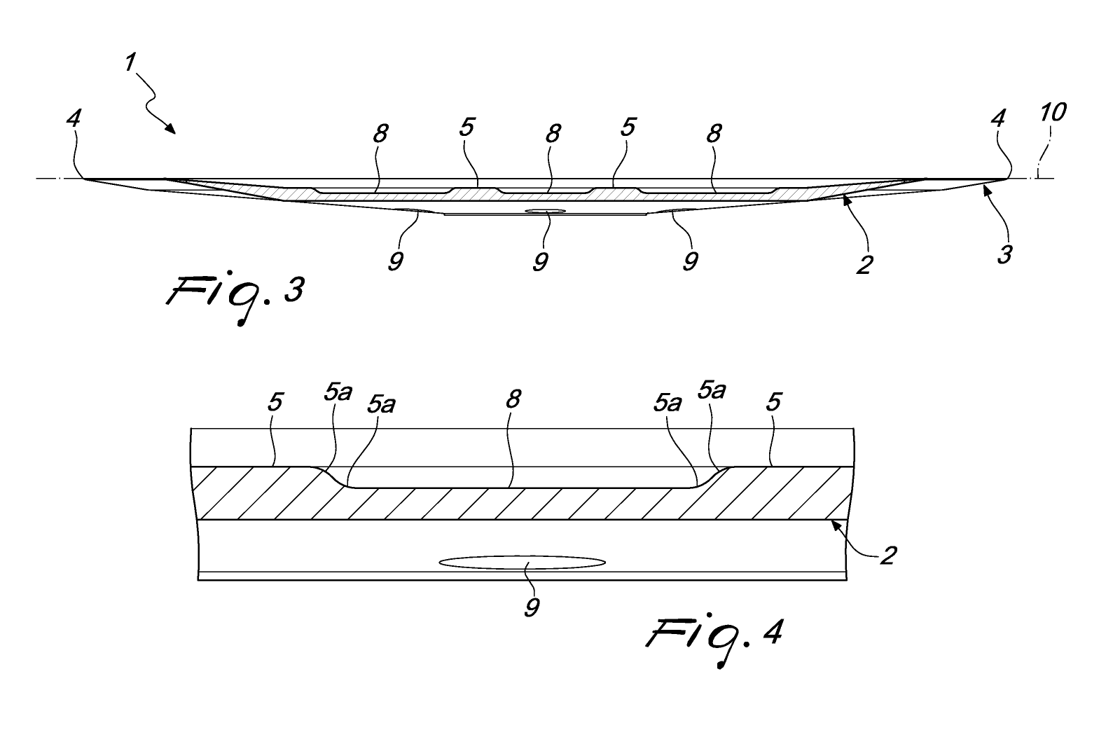

FIG. 4 is an enlarged-scale view of a detail of FIG. 3;

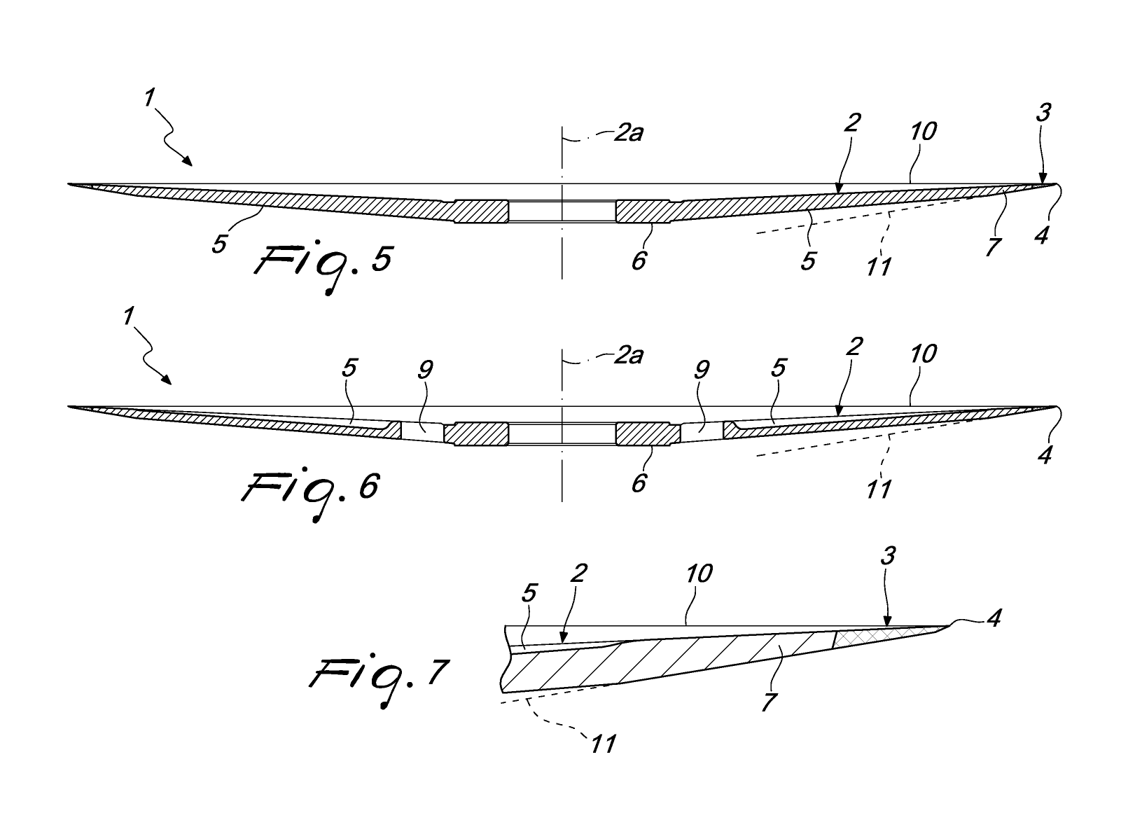

FIG. 5 is a sectional view of FIG. 2, along the plane V-V;

FIG. 6 is a sectional view of FIG. 2, along the plane VI-VI;

FIG. 7 is an enlarged-scale view of a detail of FIG. 6.

With reference to the cited figures, the blade according to the invention, generally designated by the reference numeral 1, comprises a substantially disk-like central body 2 and a peripheral annular body 3, which forms the cutting edge 4 of the blade 1 and is integrally connected to the perimetric edge of the central body 2. The peripheral annular body 3 is harder than the central body 2, which has a plurality of radial stiffening ribs 5.

Conveniently, the central body 2 is provided so as to be concave on one of its faces, constituted by the face of the blade 1 that is designed to face the product to be cut, and convex on the opposite face.

The radial ribs 5 are in relief on the concave face of the central body 2 and extend from the central region or hub 6 of the central body 2 to the annular ring 7 of the central body 2 around which the peripheral annular body 3 is connected.

More particularly, the radial ribs 5 are provided like spokes and are mutually evenly spaced around the axis 2a of the central body 2. Between the radial ribs or pseudo-spokes 5 and the annular ring 7 there are triangular sectors 8 that are substantially thinner than the radial ribs 5, as is evident from the comparison between FIGS. 5 and 6.

The central region 6 of the central body 2 is crossed by holes 9 designed to be used in order to assemble and disassemble the blade on the shaft of the slicing machine.

Conveniently, the face of the peripheral annular body 3 arranged on the concave face of the central body 2 lies on a plane 10 that is perpendicular to the axis 2a of the central body 2 and the opposite face of the peripheral annular body 3, at least in proximity to the outer perimetric edge of the peripheral annular body 3, extends along a conical surface 11 whose axis coincides with the axis 2a of the central body 2 and whose ideal apex lies along said axis 2a on the side of the convex face of the central body 2. The intersection between the conical surface 11 and the plane 10 defines the cutting edge 4 of the blade 1.

Advantageously, the central body 2 is made of hardened martensitic stainless steel.

More particularly, the material of which the central body 2 is made is constituted by a low-carbon martensitic stainless steel which as such can be hardened to values of hardness substantially comprised between 30 HRC and 40 HRC. The hardening of this material makes it possible to obtain a high corrosion resistance for the blade 1 according to the invention.

The low carbon content of the martensitic stainless steel used to provide the central body 2 allows its weldability without particular difficulties and without generating cracks. This particular characteristic of martensitic stainless steel, which can be formed by a steel of the AISI 400 series with high chromium content, such as for example an X12 Cr 13 steel or X20 Cr 13 steel, i.e., with a carbon content equal to 0.12% or 0.2%, makes it possible to obtain an optimum connection between the central body 2 and the peripheral annular body 3.

The peripheral annular body 3 is in fact made of a superalloy based on iron and is connected to the central body 2 by means of a melting process.

The iron-based superalloy used to provide the peripheral annular body 3 is composed of iron (Fe), chromium (Cr), vanadium (V), molybdenum (Mo), manganese (Mn), silicon (Si), carbon (C) and nickel (Ni).

Preferably, the iron-based superalloy is composed of:
chromium (Cr), in a percentage comprised substantially between 10% and 18%;
vanadium (V), in a percentage comprised substantially between 12% and 15%;
molybdenum (Mo), in a percentage comprised substantially between 1% and 2%;
manganese (Mn), in a percentage comprised substantially between 1% and 2%;
silicon (Si), in a percentage of substantially 1%;
carbon (C), in a percentage comprised substantially between 3% and 5%;
nickel (Ni), in a percentage comprised substantially between 1% and 5%;
iron (Fe), for the remaining part.

This iron-based superalloy achieves, for the peripheral annular body 3, a hardness substantially comprised between 60 HRC and 63 HRC. This high hardness ensures a longer life of the sharpening of the cutting edge 4 of the blade 1, reducing the number of the operations for assembly and disassembly of the blade 1 and therefore reducing machine downtime.

The high weldability of the material of which the central body 2 is made allows associating the peripheral annular body 3 around the central body 2 by means of a melting process with PTA (Plasma Transfer Arc) and/or Laser Cladding technology, making these elements completely mutually integral as if they were a single piece.

The structure of the central body 2 with the radial stiffening ribs 5 or pseudo-spokes is capable of withstanding considerable axial and radial forces, minimizing the flexing of the blade 1 when loaded during cutting with respect to the plane 10 on which the flat face of the peripheral annular body 3 lies, at right angles to the axis 2a of the blade 1. Thanks to this fact, the blade 1 according to the invention ensures high cutting precision by ensuring constant thickness of the cut slices.

Advantageously, the edges 5a of the radial ribs 5 or pseudo-spokes are connected, as shown particularly in FIG. 4. In this manner, retention of residues of the cut product is avoided effectively, cleaning of the surface of the blade 1 directed toward the product to be cut is facilitated and structural discontinuities caused by sudden variations in cross-section are avoided, thus increasing both the transverse stiffness and the radial stiffness of the blade so as to further reduce the flexing of the blade when loaded.

Essentially, providing the central body 2 in hardened martensitic stainless steel and adopting the stiffening ribs or pseudo-spokes achieves, for the blade 1 according to the invention, a high resistance against corrosion without requiring additional plating treatments and at the same time achieves a suitable resistance to stresses, reducing the deformations of the blade 1 during use. Moreover, this particular embodiment of the central body 2 allows mounting the central body 2 to the peripheral annular body 3 that forms the cutting edge 4 and that, due to its greater hardness, allows obtaining greater durability of the sharpening.

In practice it has been found that the blade according to the invention fully achieves the intended aim, since it ensures a long durability of the sharpening and a high resistance to the loads to which it is subjected and has an excellent resistance to deformations, thus making it possible to reduce machine downtime and to obtain precise cuts with a constant thickness for the slices of product that are cut.

A further advantage of the blade according to the invention is that it does not require plating treatments in order to avoid its corrosion and that it is easy and quick to clean.

The blade thus conceived is susceptible of numerous modifications and variations, all of which are within the scope of the appended claims; all the details may furthermore be replaced with other technically equivalent elements.

The disclosures in Italian Patent Application No. MI2011A002198 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-10. (canceled)

11. A circular blade for slicing machines, particularly for slicing machines of the industrial type, comprising a substantially disk-like central body and a peripheral annular body, which is integrally connected to a perimetric edge of said central body and forms a cutting edge of the blade, said peripheral annular body being harder than said central body and said central body having a plurality of radial stiffening ribs.

12. The blade according to claim 11, wherein said central body is formed concave on one face and convex on an opposite face, said radial ribs being in relief on the concave face of said central body.

13. The blade according to claim 12, wherein the face of said peripheral annular body that is arranged on the concave face of said central body lies on a plane that is perpendicular to an axis of said central body and in that the opposite face of said peripheral annular body, at least proximate to an outer perimetric edge of said peripheral annular body, extends along a conical surface whose axis coincides with the axis of said central body and with the vertex arranged along said axis on a side of the convex face of said central body, the intersection between said conical surface and said plane defining the cutting edge of the blade.

14. The blade according to claim 11, wherein said central body is made of hardened martensitic stainless steel.

15. The blade according to claim 11, wherein said peripheral annular body is made of a superalloy based on iron and is connected to said central body by melting.

16. The blade according to claim 15, wherein said iron-based superalloy is composed of iron (Fe), chromium (Cr), vanadium (V), molybdenum (Mo), manganese (Mn), silicon (Si), carbon (C) and nickel (Ni).

17. The blade according to claim 16, wherein said iron-based superalloy is composed of:
chromium (Cr), in a percentage comprised substantially between 10% and 18%;
vanadium (V), in a percentage comprised substantially between 12% and 15%;
molybdenum (Mo), in a percentage comprised substantially between 1% and 2%;
manganese (Mn), in a percentage comprised substantially between 1% and 2%;
silicon (Si), in a percentage of substantially 1%;
carbon (C), in a percentage comprised substantially between 3% and 5%;
nickel (Ni), in a percentage comprised substantially between 1% and 5%;
iron (Fe), for the remaining part.

18. The blade according to claim 11, wherein edges of said stiffening ribs are blended.

19. The blade according to claim 11, wherein said peripheral annular body has a hardness comprised substantially between 60 HRC and 63 HRC.

20. The blade according to claim 11, wherein said central body has a hardness comprised substantially between 30 HRC and 40 HRC.
